(19) United States
(12) Patent Application Publication
(10) Pub. No.: US 2011/0245457 A1
(43) Pub. Date: Oct. 6, 2011

(54) SYSTEM AND METHOD FOR RECYCLING RESIN PARTICLES

(76) Inventors: Rodney S. Rougelot, San Francisco, CA (US); Paul J. Dittmeier, Sparta, NJ (US); Frederick K. Jenz, Modesto, CA (US)

(21) Appl. No.: 12/752,780

(22) Filed: Apr. 1, 2010

(51) Int. Cl. C08F 6/12; B01D 35/18

(52) U.S. Cl. 528/486; 210/184

(57) ABSTRACT

A system and method for recycling resin particles. The system and method includes exposing resin particles to a solvent in a solvent wash tank. Within the tank, the solvent contacts the resin particles and substantially removes the contaminants. After the solvent wash, the resin particles are removed from the solvent and placed into a heated chamber of a dryer. The heated chamber facilitates the evaporation of residual solvent remaining on the resin particles, without the use of liquid or supercritical carbon dioxide, by facilitating the movement of the resin particles through the heated chamber while maintaining a heated environment within the heated chamber. In various embodiments, an alkyl lactate solvent is used in the wash tank and a vacuum may also be applied to the heated chamber, further facilitating the evaporation of the solvent off the resin particles. The system and method has been found to remove volatile polar, non-volatile polar, volatile non-polar, non-volatile non-polar substances, such as but not limited to: Benzophenone, 1-Phenyldecane, Toluene and Diethyl-Ketone, to levels that meet current FDA guidelines, including at or below 0.220 parts per million and 0.5 parts per billion after migration testing.

### FIELD OF THE INVENTION

The invention generally relates to the recycling of resin particles sufficient for reuse with food contact applications such as food and beverage containers, and more specifically, to a system and method for recycling resin particles by exposing the resin to a solvent to remove contaminants, mechanically separating the particles and the solvent, and then removing residual solvent remaining on the resin after separation by evaporation in a heated chamber.

### DESCRIPTION OF THE RELATED ART

It is now commonplace for municipalities, waste collection, and recycling companies to collect plastic bottles and other resin-based packaging material for recycling. Recycling is a highly desired alternative to sending such objects to a landfill where they take up a significant volume, do not degrade and breakdown for decades, and also create the possibility that any contaminants present on or in the plastic bottles and other resin-based packaging materials to leak into the surrounding soil and ground water. Unfortunately, recycling of such materials is often viewed as too expensive, too inefficient, and/or too likely to produce additional waste products.

The conventional method of recycling is to grind the bottles into resin particles and then rinse the particles with water. The problem with this method is that rinsing with water is not very effective. Certain contaminants, such as oils or pesticides, are difficult to remove with water. Often containers made from these plastic bottles and other resin-based packaging materials contain residues of the contaminants they once contained, and if these residues are not removed from the containers, the material may be suitable only for products that do not come in contact with humans, which makes them of lower value. In addition, the water run-off used to clean the resin is also a problem and is harmful to the environment. This water, which typically ends up in lakes, streams or the water table, is often polluted with the contaminants, such as oil, chemicals, pesticides, etc. Lastly, the aforementioned recycling process is expensive, and large amounts of water and energy are consumed during the cleaning process.

Recently a new resin recycling process and system has been developed. With this system, resin flake is cleaned and recycled in a three-stage process. In the initial stage, the resin particles are exposed to a solvent, which substantially removes the contaminant on the resin. In the next stage, the resin particles are mechanically separated from the solvent. In the third and final stage, the resin particles are exposed to carbon dioxide, in either a supercritical or liquid state, to remove any residual solvent or contaminant remaining on the resin. For more details on this resin recycling process and system, see U.S. Pat. No. 7,253,253 issued to Bohnert et al. This recycling process and system represents a significant improvement over conventional washing with water. Virtually all contaminants are removed from the resin. In addition, with closed-looped solvent wash and carbon dioxide sub-systems, the process is essentially non-polluting, uses no water, and consumes much less energy relative to conventional water-based recycling.

The aforementioned resin recycling process and system relies on a batch process to expose the resin to the carbon dioxide solvent removing agent. After removal from the solvent, the resin is passed through a separation device, such as a centrifuge, which removes most but not all of the solvent. The separated resin is then loaded, in a batch process, into one or more machines, similar to a commercial grade washing machine, for agitation and exposure to the carbon dioxide in the liquid or supercritical form. Because the solvent is highly soluble in carbon dioxide, the liquid or supercritical carbon dioxide combines with the solvent and is removed from the resin. After the residual solvent and any remaining contaminants are removed, the batch of resin is unloaded from the one or more machines and replaced with a new batch of solvent laden resin. This process of loading and unloading the resin is repeated, provided there is available resin to process. While highly effective in removing contaminants, the throughput of the batch system and method is less than ideal.

Further, there are a number of negative issues related to the use of carbon dioxide in the resin recycling process. The cost of carbon dioxide is expensive, and this cost is likely to increase in the future. The pressurizing and depressurizing the carbon dioxide consumes a great deal of energy, which is expensive. In addition, the use of carbon dioxide requires the fabrication of custom equipment, which significantly adds to the capital costs required to build a carbon dioxide based resin recycling plant. The carbon dioxide equipment also requires skilled labor to operate the machinery, increasing operation costs. Thus, including the use of carbon dioxide, in either liquid or supercritical form, minimizes the cost advantages relative to conventional water-based methods. As a result, there is little competitive advantage to building a carbon dioxide based recycling system relative to conventional water-based recycling plants.

Currently there is a significant emphasis in the United States and other countries on increasing the use of recycled materials, including plastic. In the United States, the Food and Drug Administration (FDA) has a number of safety concerns with the use of recycled plastic materials in food-contact articles. These concerns include the fear that (i) contaminants from the post consumer material may appear in the final food-contact product made from the recycled material, (ii) recycled post-consumer material not regulated for food-contact use may be incorporated into food-contact packaging, and (iii) adjuvants in the recycled plastic may not comply with the regulations for food-contact use. Currently, to address these concerns, the FDA considers each proposed use of recycled plastic on a case-by-case basis. The above-described three step process, include solvent wash, separation, and then either liquid or supercritical carbon dioxide has been approved by the FDA for the use of recycled plastic materials in food-contact articles. To the best of the applicant's knowledge, however, all water-based systems are incapable of meeting FDA approval without additional steps of including heat and/or pressure within the process.

Consequently, there is a need for a non-water based resin recycling process and method that does not rely on carbon dioxide, but is capable of meeting FDA guidelines for the use of recycled plastic materials in food-contact articles.

### SUMMARY OF THE INVENTION

The present invention is directed to a system and method for recycling resin particles. The system and method includes exposing resin particles to a solvent in a solvent wash tank. Within the tank, the solvent contacts the resin particles and substantially removes the contaminants. After the solvent wash, the resin particles are removed from the solvent and placed into a heated chamber of a dryer. The heated chamber facilitates the evaporation of residual solvent remaining on the resin particles, without the use of liquid or supercritical carbon dioxide, by facilitating the movement of the resin particles through the heated chamber while maintaining a heated environment within the heated chamber. In various embodiments, an alkyl lactate solvent is used in the wash tank and a vacuum may also be applied to the heated chamber, further facilitating the evaporation of the solvent off the resin particles. The system and method has been found to remove volatile polar, non-volatile polar, volatile non-polar, non-volatile non-polar substances, such as but not limited to: Benzophenone, 1-Phenyldecane, Toluene and Diethyl-Ketone, to levels that meet current FDA guidelines, including at or below 0.220 parts per million and 0.5 parts per billion after migration testing.

### BRIEF DESCRIPTION OF THE DRAWINGS

The invention may best be understood by reference to the following description taken in conjunction with the accompanying drawings, which illustrate specific embodiments of the invention.

FIG. 1 is a block diagram of a resin recycling system according to the present invention.

FIG. 2 is a first embodiment of a solvent wash stage used in the resin recycling system of the present invention.

FIGS. 3A and 3B are a second embodiment of a solvent wash stage used in the resin recycling system of the present invention.

FIG. 4 is a third embodiment of a solvent wash stage used in the resin recycling system of the present invention.

FIG. 5A is a first embodiment of a drying stage used in the resin recycling system according to the present invention.

FIG. 5B is an exposed view of a dryer used in the drying stage of either FIG. 5A or 5C according to the present invention.

FIG. 5C is a second embodiment of a drying stage used in the resin recycling system according to the present invention.

FIG. 6 is diagram illustrating a sequence for recycling resin according to the present invention.

FIG. 7 is a diagram illustrating a sequence for removing PCBs from automotive and other industrial plastics according to the present invention.

It should be noted that like reference numbers refer to like elements in the figures.

### DETAILED DESCRIPTION OF SPECIFIC EMBODIMENTS

The present invention is directed a system and method for removing contaminants from resin particles, such as those derived from post-consumer containers made from synthetic resin material. The present invention is particularly useful in the removal of soda, oil, milk, pesticides, detergents, from polyethylene terephthalate (PET), high-density polyethylene (HDPE) and other contaminants from various other post-consumer containers, such as those collected from curbside recycling programs. In addition, the system and method of the present invention is highly effective in removing labels and label adhesive from synthetic resin material containers. The system and method is also highly effective in removing polychlorinated biphenyl (PCB) contaminants, particularly from automotive plastics. Furthermore, the system and method facilitates contaminant recovery from the recycled synthetic resin materials, thereby enabling the contaminants to be disposed of in a safe and environmentally friendly manner.

The FDA is the agency in the United States responsible for setting guidelines, testing and providing approval for the reuse of recycled resin material for packaging of foods and beverages used for human consumption. In general, the FDA is mainly concerned with the removal of volatile polar, non-volatile polar, volatile non-polar, non-volatile non-polar substances, such as, but not limited to Benzophenone, 1-Phenyldecane, Toluene and Diethyl-Ketone, as well as other chemicals and heavy metals. The FDA requires that any resin recycling process remove the above-listed substances, chemicals and heavy metals to at least 0.220 parts per million (ppm). If any of the above is greater than 0.220 ppm after processing, then typically migration testing is performed where the target for approval is 0.5 parts per billion. Specific details on the guidelines, testing and approval process can be found on the web site of the FDA. The above-listed substances and chemicals should be considered as exemplary and not limiting in any way. It should be understood that the resin recycling system and method, as described herein, is useful for removing a wide variety of contaminants from resin particles and not just those mentioned herein. Consequently, in the event FDA guidelines change in the future, the system and method as described herein, may be suitable for meeting the new guidelines as well.

The resin recycling system and method, as described herein, is capable of producing recycled resin of a cleanliness level that satisfies FDA requirements for use of recycled resin in food contact applications. Through actual testing, it has been found that the recycling of resin is cleaned and the above-listed substances, chemicals and heavy metals are removed to levels below 0.220 parts per million and/or below 0.5 parts per billion after migration testing using the system and method as described herein.

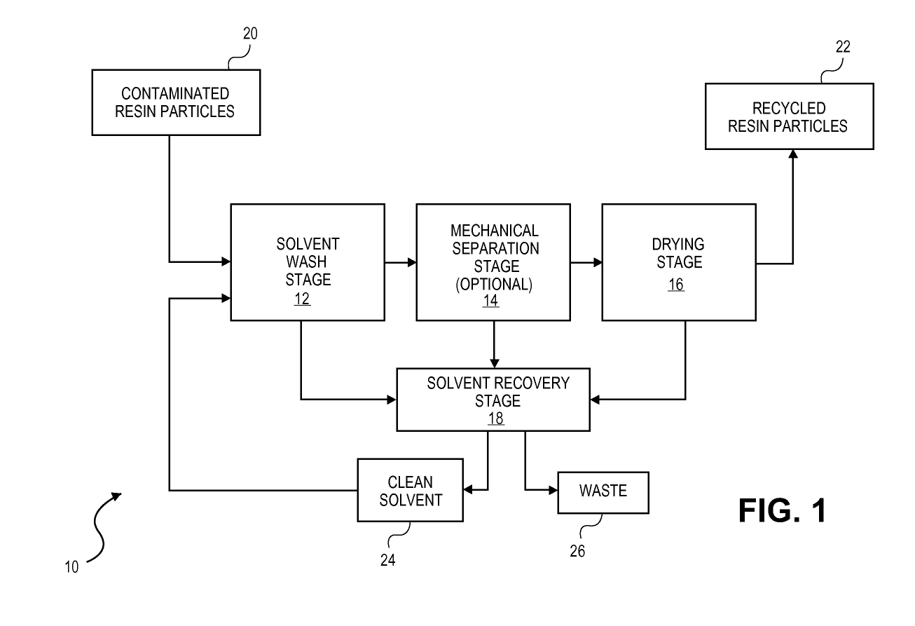

Referring to FIG. 1, a block diagram of a resin recycling system according to the present invention is shown. The system 10 includes a solvent wash stage 12, an optional mechanical separation stage 14, a drying stage 16, and a solvent recovery stage 18. A supply 20 of contaminated resin particles are provided to the solvent wash stage 12, where the resin is placed in contact with the solvent, which substantially removes the contaminants. After the solvent wash, the solvent-laden resin is optionally transported to the mechanical separation stage 14, where the solvent is substantially removed from the particles. In the next stage 16, the resin particles are dried, removing residual solvent remaining on the particles after mechanical separation by evaporation. As the particles exit the drying stage 16, the particles are substantially free of both contaminant and solvent.

In one embodiment, the mechanical separation stage 14 includes a spin dryer, which spins the resin particles, removing a substantial portion of the solvent by centrifugal force. In a second embodiment, the resin particles may be placed in a sieve or colander type device, allowing the solvent to drip off and separate from the resin particles. In yet another embodiment, a hydro cyclone may be used to separate solid waste materials present in the solvent laden resin particles after removal from the solvent and before mechanical separation using either the spin dryer or sieve. In yet other alternatives, any combination of the above-mentioned embodiments may be used to remove solvent from the resin particles. In any case, at least 90% of the solvent is removed by weight, and more preferably 97% to 99% percent of the solvent is removed from the resin particles by the mechanical separation. In an alternative embodiment, the resin particles may be transported from solvent wash stage 12 directly to the drying stage 16, without first spinning the particles to remove the solvent.

The solvent recovery stage 18 receives contaminants from the solvent collected from the solvent wash stage 12, the mechanical separation stage 14 and the drying stage 16. In one embodiment, the solvent recovery stage relies on distillation to remove the contaminants, resulting in clean solvent 24 that may be reused in the solvent wash stage 12. For example, the dirty solvent may be heated to create a vapor, which is then cooled, allowing the contaminants to precipitate out of the liquid and the vapor to be condensed back into pure, clean solvent. The resulting clean solvent 24 is then available for re-use, while the waste contaminants are collected at one location 26, facilitating the disposal of the material in a safe and environmentally friendly manner. In contrast with water-based resin recycling systems, the contaminants are typically not captured and safely disposed, but rather re-enter the environment in the form of water run-off.

In various embodiments, different solvents may be used in the solvent wash stage 12. Suitable solvents may be selected from various classes of chemicals such as esters, ketones, glycols, glycol ethers, halogenated solvents, aromatics, alcohols, aliphatic hydrocarbons, amines, and terpenes. More specifically, the solvent is selected from the group consisting of amyl propionate, butyl butyrate, alkyl lactates, ethyl hexyl acetate, dibasic esters, methyl soyate, ethyl soyate, cyclohexanone, methyl ethyl ketone, dipropylene glycol, dipropylene glycol methyl ether, trichloroethylene, xylene, ethanol, tetrahydrofurfuryl alcohol, hexane, mineral spirits, monoethanolamine, d-limonene, dimethyl formamide, n-methylpyrrolidone, propylene carbonate, and combinations thereof. Preferably, the solvent is an alkyl ester solvent having the general formula RCOOR′, wherein R and R′ are independently selected from C.sub.1-C.sub.10 alkyl groups and R contains at least one hydroxyl group. Alkyl lactates are particularly preferred solvents for use with the present invention.

In various specific embodiments, alkyl lactates include methyl lactate, ethyl lactate, isopropyl lactate, and butyl lactate. Of the alkyl lactates, ethyl lactate is particularly preferred. These solvents exhibit specific gravities at 20 degrees C. between 0.98-1.09, are generally miscible with water, and have a high capacity for solvating various organic contaminants such as grease and oil. Furthermore, these solvents are relatively non-toxic and, in some instances, have been approved by the FDA for food contact applications. The lack of solvent toxicity is an added benefit and contributes to the environmentally friendly nature of this system.

Solvent compatibility with the synthetic resin material is also an important property as it is undesirable for the solvent to solvate the synthetic resin material in addition to the contaminants. In various embodiments, synthetic resin materials such as polypropylene, polyethylene, high density polyethylene, terephthalate, nylon, polytetrafluoroethylene, polytetrafluoroethylene, polyvinylidene fluoride, polycarbonate, fluorinated ethylene propylene, polybutylene terephthalate, polyimide, polyetherketone, polyetherimide, polybutylene, polyphenylene oxide, polystryene, polysulfone, polyethersulfone, polymethylpentene, polyvinyl chloride, acetal, acrylic, acrylonitrile-butadiene-styrene (ABS), and combinations thereof, may all be recycled in the system 10, using the above-listed solvents.

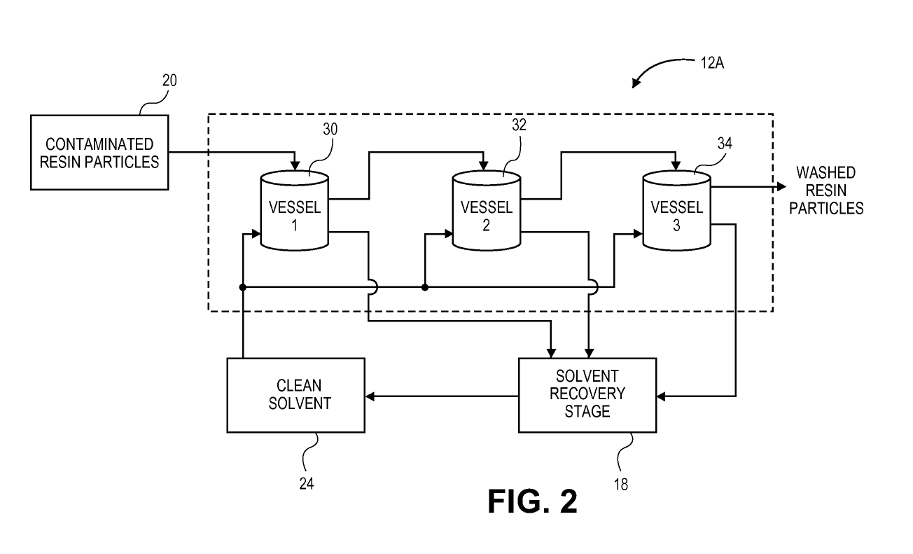

Referring to FIG. 2, a first embodiment of a solvent wash stage 12 used in resin recycling system 10 is shown. In this embodiment, hereafter referred to using the reference numeral 12A, three wash tanks 30, 32 and 34 are provided, each filled with solvent. A jacket surrounds the outer surface of each of the tanks 30, 32, and 34. The jacket contains a heat transfer fluid, such as glycol, that is used to heat the solvent contained in the tanks. In various embodiments, the solvent in the tanks 30, 32 and 34 are heated within the range of 90 degrees to 190 degrees F. and preferably between 115 and 130 degrees F. In addition, each of the tanks 30, 32 and 34 includes an agitator, such as a Neptune mixer, that agitates the resin particles to ensure maximum contact with the solvent.

In one optional embodiment of the solvent wash stage 12A, a solvent may be chosen with a selected specific gravity to implement a sink-float system for the separation of resin particles with different densities. If the resin particles contain both PET and polypropylene, the two types of material can be separated in the tanks 30, 32 and 34 by using a solvent with a specific gravity between the two. For example, polypropylene exhibits a specific gravity of about 0.90, whereas PET generally exhibits a specific gravity of between about 1.3-1.4. To implement the sink-float separation of these two materials, the selected solvent should have a specific gravity in between these two figures, and more preferably will have a specific gravity proximate to that of water. In various embodiments, the solvent has a specific gravity (preferably at 20 degrees C.) of 0.76 or more, more preferably between about 0.9-1.5, and most preferably between about 0.95-1.25. If flotation separation is not a critical feature of a particular solvent wash stage, then the specific gravity of the solvent is not as a factor.

During operation, contaminated resin particles 20 are fed into the first tank 30. The resin particles are agitated in the heated solvent for a predetermined length of time. The length of time may depend upon many factors such as tank size, solvent purity, the nature of the solvent itself, and the capacity of the solvent for solubilizing the particular contaminants. In various embodiments, the agitation may occur over a relatively short time period, preferably less than 15 minutes, more preferably between 1-12 minutes, and most preferably between about 4-5 minutes. At the end of the agitation cycle, the resin particles are transported to the second tank 32, where the above-defined agitation cycle is repeated. Thereafter, the agitation cycle is repeated in the third tank 34. After three solvent washes, the clean resin particles are provided to either the mechanical separation stage 14 or the drying stage 16.

In one embodiment, the resin is streamed to the second and third tanks 32 and 34 and the subsequent stage 14 or 16 in the form of a slurry of resin particles and solvent. In yet another embodiment, the purity level of the solvent successively increases in the tanks 30, 32 and 34 respectively. In this manner, the resin particles are exposed to cleaner solvent as the particles pass through the three tanks 30, 32 and 34 respectively. For more details of the solvent wash stage 12A, see U.S. Pat. No. 7,253,253, incorporated by reference herein for all purposes.

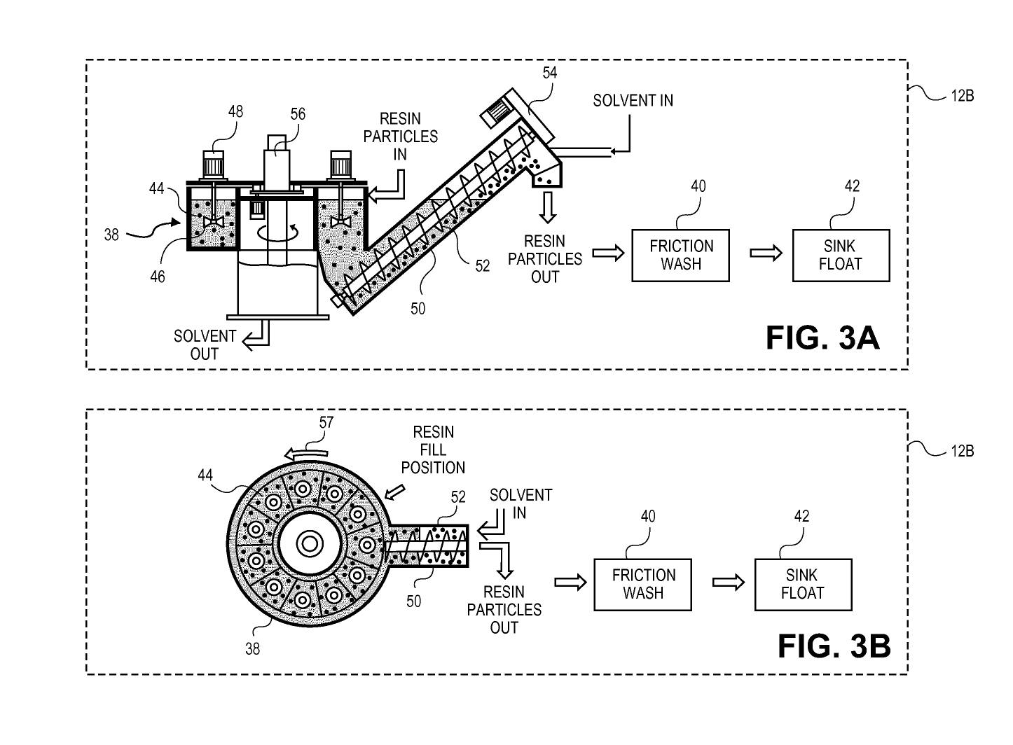

Referring to FIGS. 3A and 3B, a second embodiment of the solvent wash stage 12 of the resin recycling system 10 is illustrated. In this embodiment, the solvent stage, hereafter referred to using the reference numeral 12B, includes a continuous hot wash tank 38, a frictional wash stage 40 and a sink-float stage 42.

The hot wash tank 38 includes a plurality of individual wash chambers 44 arranged in a carousel within the tank 38. An agitator 46, driven by a motor 48, is provided for each chamber 44. The hot washer tank 38 also includes a particle exit chute 50, which includes particle removal screw 52 rotated by motor 54. A motor 56 is provided for rotating the carousel of wash chambers 44 within the wash tank 38. In the embodiment shown, the carousel of wash chambers 44 rotates in a counter-clockwise direction, as indicated by arrow 57. In an alternative embodiment, the carousel may be rotated in the opposite direction.

During operation, heated, clean solvent is provided through the particle exit chute 50 to fill the hot wash tank 38, including the individual wash chambers 44. The carousel of wash chambers 44 is continuously rotated in the wash chamber 38. As each wash chamber 44 passes the “resin fill position”, a predetermined amount of contaminated resin particles is introduced into each chamber. As the carousel revolves, the agitators 46, driven by the motors 48, agitate the particles in the solvent within each chamber 44 respectively, removing contaminants and cleaning the resin. Each chamber 44 eventually rotates to the position adjacent to the exit chute 50, where the resin particles are released from the chamber 44 into the bottom of exit chute 50. The rotating screw 52 then transports the resin particles up the chute 50 and out of the hot wash tank 38. As the carousal continues to spin, the chamber 44 that just released the resin is refilled at the fill position. The aforementioned process is continuously repeated for each chamber 44 as the carousel rotates within the hot wash tank 38. In one embodiment, a steady supply of clean, heated solvent is provided from a heating storage unit (not shown) remote from the hot wash tank. In an alternative embodiment, procedures may be taken to heat or maintain the heat of the solvent within the wash tank 38. For example, the wash tank 38 may be surrounded by a heating jacket and heating fluid, such as glycol, may be circulated through the jacket, thereby heating the solvent in the wash tank 38 to a desired temperature or temperature range. In yet another embodiment, both, or other heating procedures, may be used.

In one embodiment, dirty or contaminated solvent is continuously removed from the bottom of the hot tank 38. By continuously replenishing the removed dirty solvent with clean, heated, solvent introduced through chute 50, the solvent in the hot wash tank 38 remains relatively clean and hot, and does not become overly saturated with contaminants. In one specific embodiment, all the solvent in the hot tank 38 is flushed and replenished every 25 minutes, or at a rate of approximately 2.5 times per hour. It should be understood that rate is exemplary and should not be construed as limiting. Other rates may be chosen depending on a host of factors, such as the contamination levels of the resin prior to entering the tank 38, the duration the resin particles spend in the tank, tank size, solvent purity, the nature of the solvent itself and the capacity of the solvent for solubilizing the particular contaminants, etc. In one specific embodiment, a continuous hot washer system from B+B Anlagenbau GmbH. Tempelsweg, Germany may be used for the solvent wash system 12B.

The rotational speed of the chambers 44 determines the amount of time the resin particles are exposed to the solvent. The faster the rotational time, the shorter the exposure time, and vice-versa. The desired or actual rotational time for a complete revolution of the individual chambers 44 may depend upon a number of factors, such as tank size, solvent purity, the nature of the solvent itself and the capacity of the solvent for solubilizing the particular contaminants. The solvent purity is determined by a number of factors, including the replacement rate, the contaminant level of the resin particles, and the volume of solvent in the tank 38. In various embodiments, the temperature of the solvent may range from 90 to 190 degrees F., the amount of resin material provided in each chamber 44 ranges from 10 to 150 pounds, and the exposure time of the resin particles in the solvent ranges from 8 to 16 minutes.

After removal from the hot wash tank 38, the resin particles are provided to the friction wash system 40 and then sink float system 42. The friction wash system 40 is used for an additional cleaning step for difficult to remove dirt or adhesives trapped in the resin particles. In one embodiment, the friction wash system 40 includes a long, rapidly rotating rotor that conveys the resin particles adjacent a screen basket. As the resin moves relative to the screen of the basket, a high level of friction is produced on the surface of the particles, causing the removal of the dirt and adhesives. The basket screen and the rotor are also continuously rinsed in solvent against the direction of resin particle movement, so that the friction washer always remains clean. In one embodiment, a friction washer from B+B Anlagenbau GmbH, Tempelsweg, Germany may be used for the friction wash system 40. The sink float system 42 is used to separate different types of resin particles by density, as described above.

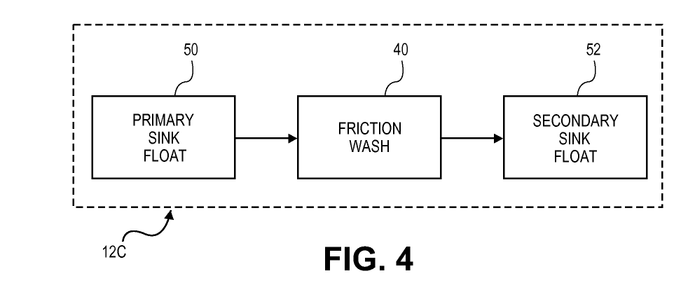

Referring to FIG. 4, a third embodiment of a solvent wash stage used in resin recycling system 10 of the present invention is shown. In this embodiment, the solvent stage, hereafter referred to using the reference numeral 12C, includes a primary sink float system 50, a friction wash system 40, and a secondary sink float system 52. During operation, the primary sink float system 50 is used to both clean resin particles and separate different types of resin particles by density. Once separated, each type of resin is friction washed in system 40 and then provided to the secondary sink float system 52, where the particles are again washed in the solvent. Any remaining particles of a different density, not separated in the primary, are separated in the secondary sink-float operation. For more information on the embodiment shown in FIG. 4, see product offering such as the recycling PET reclaiming plant equipment from a company named AMUT, Novara, Italy.

In one embodiment, dirty solvent used in the wash stages of the embodiments of 12A, 12B and 12C may each be continuously removed and continuously replenished with clean solvent. In each case, clean solvent is continuously provided to the wash tank at approximately the same rate dirty solvent is continuously removed. In this manner, the volume of the solvent remains the same, while the purity concentration always remains sufficient for effective cleaning without becoming overly saturated with contaminants. Alternatively, the all the solvent in a wash tank may be periodically removed and replaced with clean solvent. In either case, the contaminated solvent is passed through the recovery stage 18, resulting in the clean solvent that may be reused. In addition, any solvent collected during the mechanical separation at stage 14 or during the drying stage 16 may also be cleaned by solvent recovery stage 18 and reused, as discussed in more detail below. The replenishing rate, or the period between replacing all the solvent is determined by a number of factors, such as the size of the wash tank, the amount or volume of solvent in the wash tank, the contamination levels of the resin particles, and volume of resin washed.

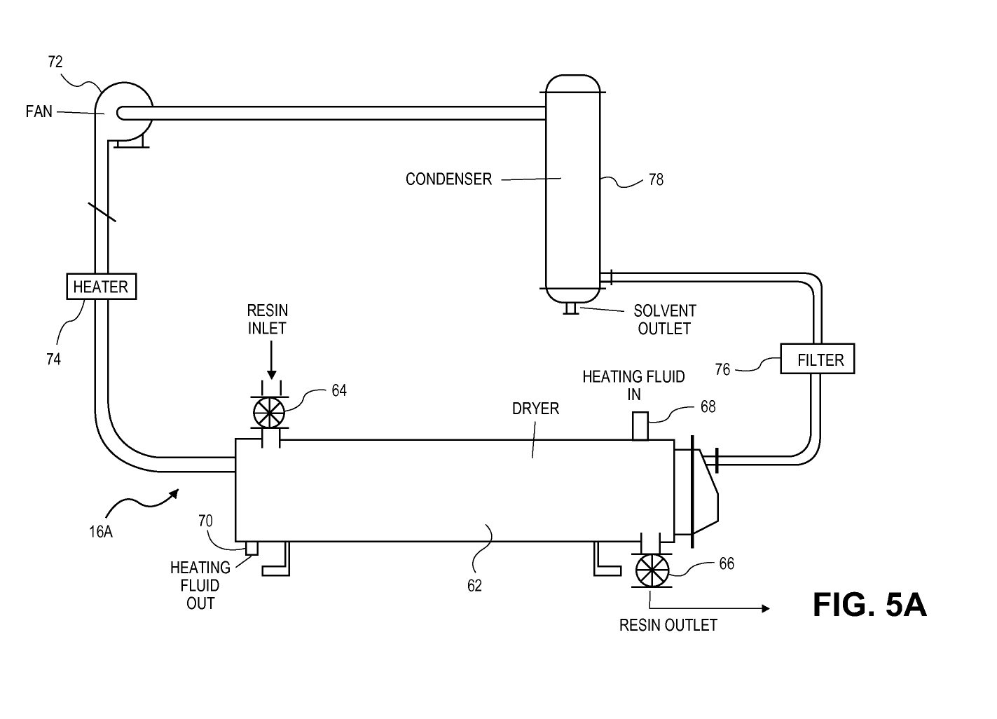

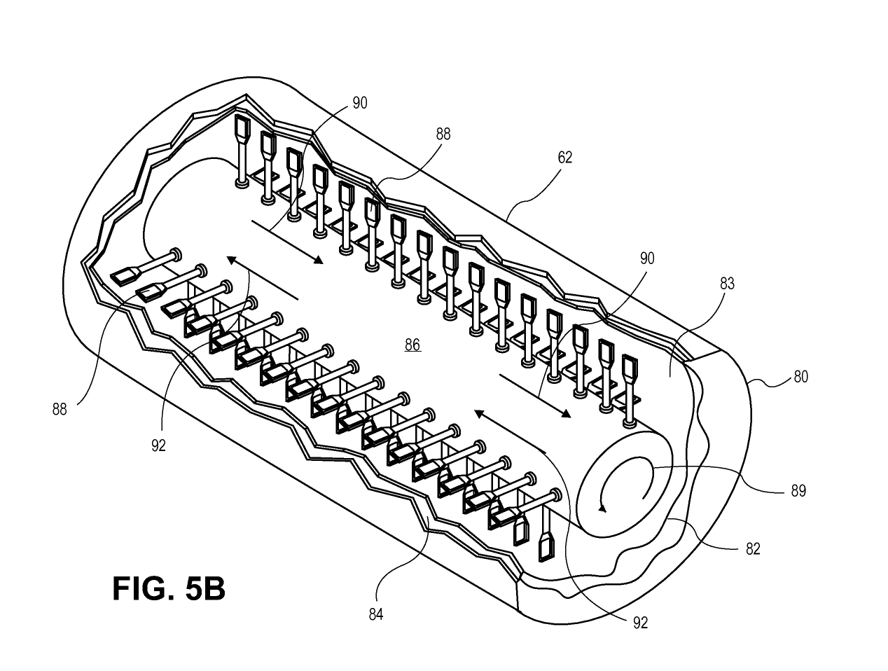

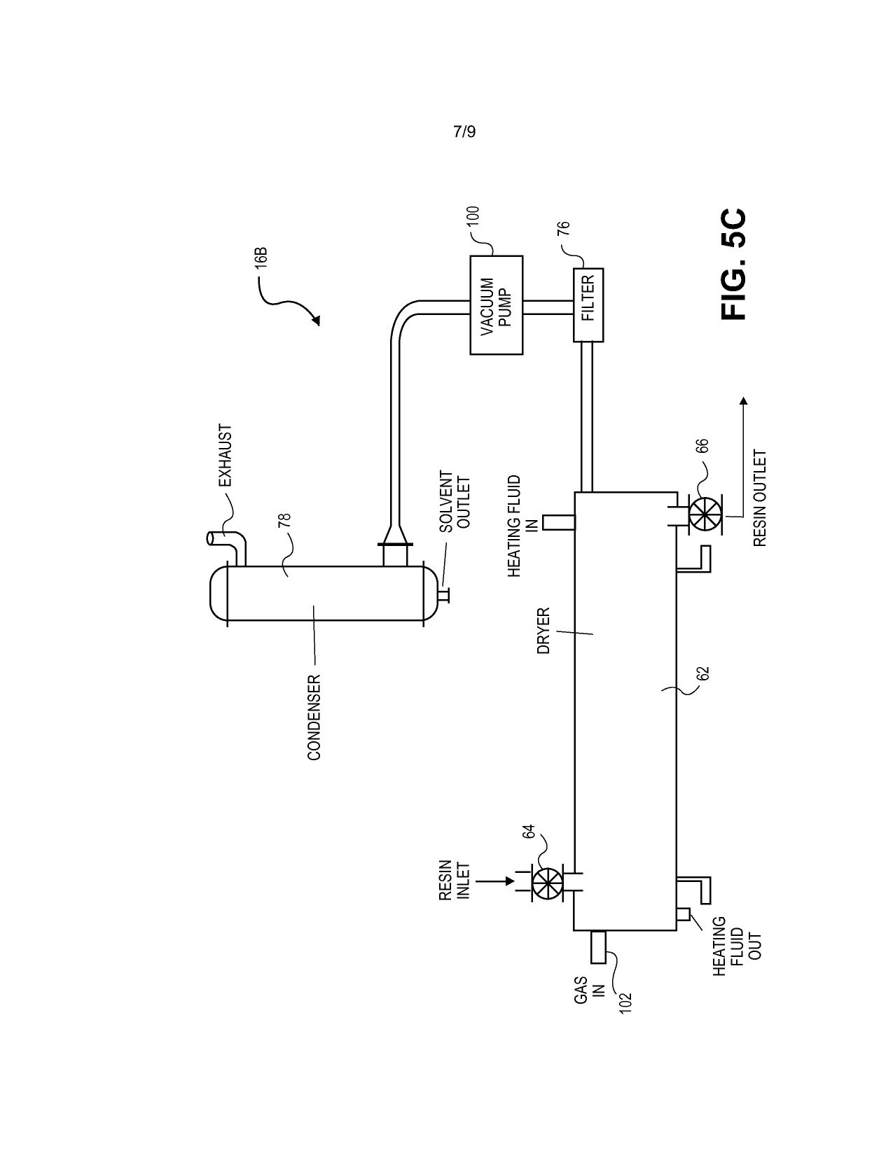

Referring to FIG. 5A, a first embodiment of a drying stage used in the resin recycling system 10 according to the present invention is shown. In this embodiment, the drying stage 16, hereafter referred to using the reference numeral 16A, includes a dryer 62 with a resin particle inlet 64 and outlet 66, a heating fluid inlet 68 and outlet 70, a fan 72, heater 74, filter 76 and condenser 78. The heating fluid inlet 68 and outlet 70 are provided for supplying and removing a heating fluid in and out of the dryer 62 respectively. The heating fluid, such as hot oil or steam, is used for heating an internal drying chamber (not visible) within the dryer 62. In addition, the fan 72 and the heater 74 are responsible for blowing hot air through the drying chamber.

During operation, resin particles with residual solvent are continuously fed into inlet 64 and travel through the heated drying chamber to the resin outlet 66 of dryer 62. As the particles travel through the dryer 62, hot air is blown through the drying chamber in the same direction. The combination of the chamber heated by the heating fluid and the hot air causes the solvent to evaporate off the resin. As a result, substantially dry resin exits the dryer 62 through outlet 66, while air and the evaporated solvent exits the dryer 62 and is provided through the filter 76 to the condenser 78. The filter 76 removes any solid contaminants, such as paper or fines, carried by the hot air passing through the dryer 62. Within the condenser 78, the hot air is cooled, allowing the solvent to precipitate out. The liquid solvent may then be provided to the solvent recovery stage 18, where it is cleaned for reuse.

FIG. 5B is an exposed or cut-away view of the dryer 62. The dryer 62 includes an external housing 80 and an internal chamber housing 82, which defines the internal drying chamber 83. A gap 84 is provided between the walls of the external housing 80 and the internal chamber housing 82. The gap 84 is filled with the heating fluid to heat the internal chamber of housing 82. In addition, a shaft 86 is provided within the internal drying chamber 83. Paddles 88 extend outward from the shaft 86. The shaft 86 and the paddles 88 are configured to rotate within the internal drying chamber 83, as designated by arrow 89. In various embodiments, the temperature within the chamber 83 ranges from 225 to 300 degrees F.

During operation, the internal chamber 83 is heated by the heating fluid circulating through the gap 84 between the external wall 80 and the internal wall 82. In addition, hot air is passed through the chamber 83, in the direction designed by arrows 90. As the resin enters the chamber 83, the paddles 88 on the rotating shaft 86 continually agitate the particles in the heated chamber and press the particles against the heated walls of the heated chamber 83, maximizing the exposure of the surface area of the particles to the heat and hot air. By angling the direction of the paddles, the resin particles are transported from the inlet 64 to the outlet 66 of the dryer 62 as the shaft 86 rotates, as designated by the direction of arrows 92. The combination of the elevated temperature in the chamber caused by the heating fluid, plus the hot air passing through the chamber 83, causes the evaporation of the solvent, resulting in dry resin particles exiting the dryer 62. An example of a commercially available dryer that can be used for the dryer 62 is a Solidaire dryer from Bepex International, Minneapolis, Minn.

FIG. 5C is a second embodiment of a drying stage used in the resin recycling system according to the present invention. In this embodiment, a dryer 62 with an internal heating chamber 83 (not visible) is used. The chamber 83 is heated by circulating the heating fluid between the through the gap 84 between external housing 80 and the internal chamber housing 82, as described above. A vacuum pump 100 is used to pull a vacuum within the chamber 83, as opposed to blowing hot air into the chamber as used in the embodiment of FIG. 5A. During operation, resin particles are introduced into the dryer 62 through inlet 64 and exit through outlet 64. The shaft 86 and the paddles 88 rotate, causing the particles to be agitated and pressed against the heated walls, of the chamber 83, causing the solvent to evaporate. The vacuum pulled though the chamber tends to not only reduce the temperature at which the solvent evaporates, but also draws the evaporated solvent in the chamber through filter 76 and to the condenser 78, where the solvent is cooled and returned to a liquid state. In another embodiment, an inert gas such as nitrogen or carbon dioxide is provided into the chamber 83 through a gas inlet 102. The gas acts as a “sweep” that helps or facilitates the removal of the evaporated solvent from the chamber 83. By maintaining a vacuum within the chamber 83, the temperature required for the evaporation of the solvent is reduced, meaning either a lower operating temperature within the chamber may be used or the solvent will evaporate at a higher rate for a given temperature relative to the embodiment shown in FIG. 5A. For example, with the vacuum environment, the temperature range within the chamber 83 may range from 225 to 300 degrees F., more solvent is likely to evaporate at this temperature range with the vacuum than without the vacuum.

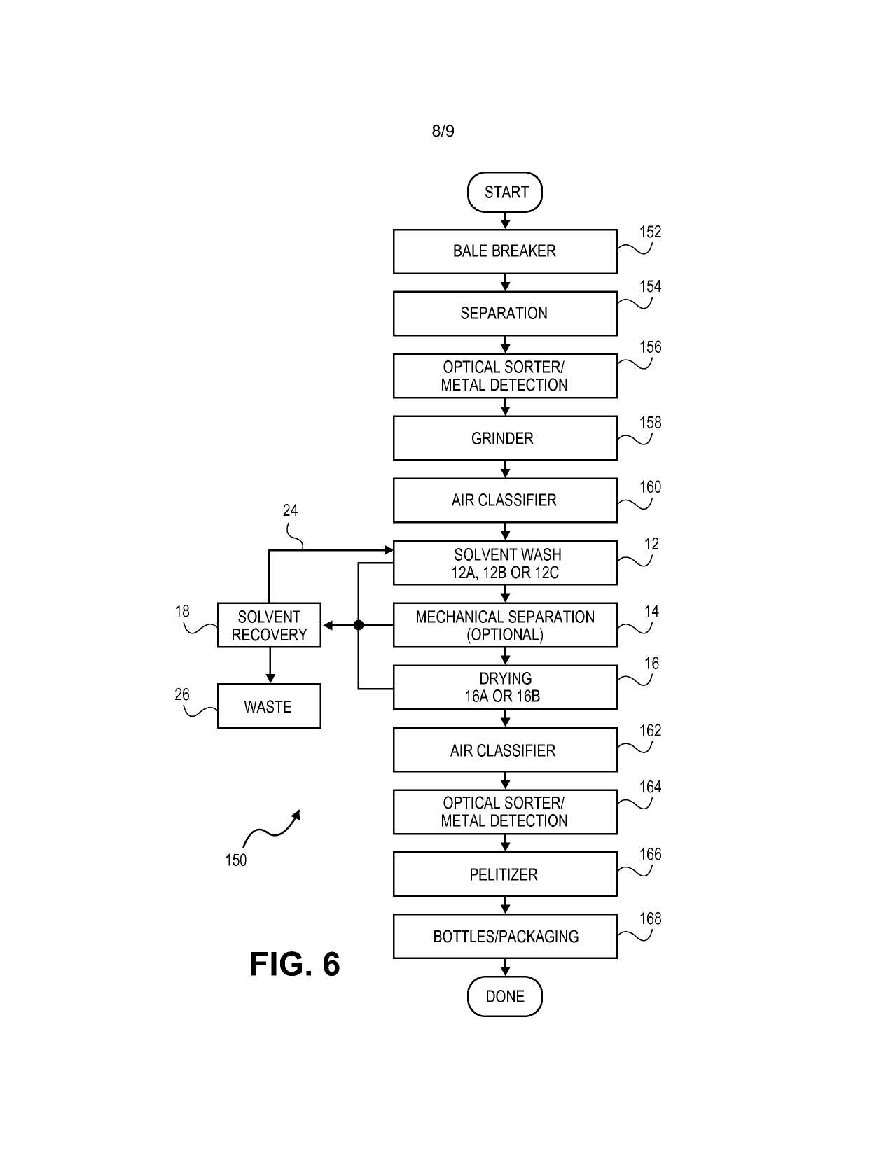

Referring to FIG. 6 a diagram illustrating a system and method for recycling resin according to one embodiment of the present invention is shown. The system and method includes one or more bale breakers 152, a separator 154 used to separate the baled resin, one or more optical sorters 156, one or more grinders 158, one or more air classifiers 160, a solvent wash stage 12 (including any of the embodiments 12A, 12B or 12C described above), mechanical separation stage 14, drying stage 16 (including any of the embodiments 16A or 16B described above), an air classifier 162, an optical and/or infrared sorter 164, pelletizer 166, and finally a stage 168 for processing the recycled resin into plastic bottles or other packing material.

During operation, resin to be recycled arrives at the recycling facility in the form of bales of compressed resin containers. As the bales are received, a bale breaker 152 removes the wires holding the bale together. In the next step 154, the compressed resin containers are separated. In one embodiment, a trommel is used to repeatedly lift, rotate and drop the bales of resin in a tumbling action, causing the individual containers to separate upon impact. Debris such as bottle caps and dirt are loosened by the tumbling action and typically fall to the wayside. As the resin containers are tumbled in the trommel, they eventually separate and are forwarded to an optical sorter 156. In one embodiment, an optical sorter 156 separates the individual containers by color (i.e., clear and green). The sorted material is then fed into a grinder 158, where the resin is ground into particles, typically ⅜-inch flake. Thereafter, the particles undergo the solvent wash stage 12, mechanical separation stage 14 and drying stage 16, using any of the above-described different embodiments. The air classifier stage 162 removes any remaining particles of paper, such as pieces of labels, fines or other fragments, not previously removed from the cleaned resin particles. The resin particles may then undergo yet another sorting by sorter stage 164 to remove any resin of the wrong color or type to a very high degree of accuracy. The sorted particles may then be pelletized by the pelletizer stage 166 before being processed into bottles or other packaging material in stage 168, using completely recycled resin, or a mix of recycled and virgin resin. For more details on forming bottles and other containers using recycled resin, see for example U.S. application Ser. No. 11/734,615 filed Apr. 12, 2007 and entitled “Method of Making Containers from Recycled Plastic Resin”, incorporated by reference herein for all purposes.

It should be noted that the system and method illustrated in FIG. 6 is merely exemplary. Many of the stages 152 through 168 (except the solvent wash stage 12 and air drying stage 16) should all be considered as optional. Actual embodiments do not necessarily need each and every one of the stages or functions listed above. For example, pre-sorted resin particles may be provided to a given recycling facility, thereby eliminating many or all of the pre-solvent wash stages. Or alternatively, clean or recycle resin particles can be shipped to another facility, where they are pelletized and formed into packaging, such as bottles for soft drinks or other food and beverages. The diagram of FIG. 6 should therefore not be construed as limiting, but rather as illustrative of one possible embodiment of a facility for recycling resin.

In the auto industry, companies are striving to reuse the plastics found in cars that have reached the end of life. At the end of the life of a car, an auto shredder is typically used to shred the car into pieces. The component parts of the car are then separated and recycled. In the past, auto plastics, however, typically could not be recycled. Often during the shredding process, PCB comes into contact with the plastic. Since PCB is a dangerous contaminant that is not easily removed with conventional water-based plastic recycling methods, most of the auto shedder plastic ended up in landfill, where the harmful PCBs re-entered the environment.

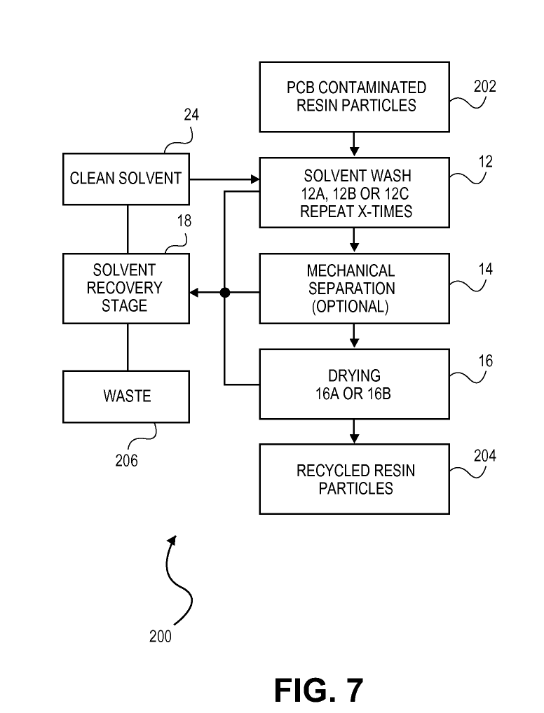

Referring to FIG. 7, a diagram illustrating a system and method for recycling resin contaminated with PCBs according to one embodiment of the present invention is shown. With this embodiment, resin particles 202 contaminated with PCB are provided to the solvent was stage 12, where any of the embodiments 12A, 12B or 12C may be used to remove the PCB from the resin. In various embodiments, the resin particles may be passed through the wash stage one or more times (i.e., X-times). With each pass, the level of PCB is reduced. When the desired contamination level is reached, the resin particles are optionally provided to the mechanical separation stage 14 and the drying stage 16, where either the embodiments 16A or 16B may be used, resulting in clean or recycled resin particles 204. Contaminated solvent from the three stages 12 (12A, 12B, or 12C), 14 and 16 (16A or 16B) is provided to the solvent recovery stage 18, resulting clean solvent 24 that may be reused and the collection of PCB and other contaminants in one location 206, facilitating disposal in a safe and environmentally friendly manner.

The system and method as described herein meets FDA approval guidelines and is capable of removing volatile polar, non-volatile polar, volatile non-polar, non-volatile non-polar substances, such as, but not limited to, Benzophenone, 1-Phenyldecane, Toluene and Diethyl-Ketone, as well as other chemicals and heavy metals. Actual tests have demonstrated results meeting the 0.220 parts per million and 0.5 parts per billion after migration testing thresholds. As noted above, the applicants are not aware of any water-based system or methods that meet FDA approval guidelines, unless subsequent processing steps relying on heat and/or extrusion are performed. These added steps involve significant investments in capital equipment and increased operating costs beyond the costs of cleaning the resin. The disadvantage of any water-based system and method, however, regardless if the process meets FDA guidelines or not, is that it requires significant amounts of water. Besides the cost and scarcity of water, the resulting run-off is usually contaminated with the chemicals used in the cleaning process, which reenter the environment. While known carbon dioxide based recycling systems have met FDA guidelines and offer advantages over water-based recycling, the use of carbon dioxide is very expensive and capital equipment intensive, resulting increased capital and operational costs. As a result, carbon dioxide based systems are, in general, not economically feasible.

It is believed that the system and method, as described herein, is the first resin recycling system and method that meets FDA guidelines without the use of water and/or carbon dioxide. In addition, by using a closed loop solvent system, contaminants are collected in one location, facilitating removal of these pollutants in a safe and environmentally safe manner.

Although one or more different embodiments of the method and systems as described above may be used, it will be appreciated by one of skill in the art that multiple other embodiments be used and practice the techniques of the present invention described herein. It should be understood by those skilled in the art that a variety of changes in the form and details of the disclosed embodiments may be made without departing from the spirit or scope of the invention. It is therefore intended that the invention be interpreted to include all variations and equivalents that fall within the true spirit and scope of the invention.

What is claimed is:

1. A method for recycling resin particles, comprising:
exposing resin particles to a solvent in a solvent wash tank, the solvent contacting the resin particles in the solvent wash tank to substantially remove contaminants on the resin particles;
removing the resin particles from the solvent in the solvent wash tank; and
drying the removed resin particles in a heated chamber, the heated chamber facilitating the evaporation of residual solvent remaining on the resin particles without the use of liquid or supercritical carbon dioxide by facilitating the movement of the resin particles through the heated chamber while maintaining a heated environment within the heated chamber.

2. The method of claim 1, wherein the solvent used in the solvent wash tank is an alkyl lactate solvent.

3. The method of claim 2, wherein the alkyl lactate solvent consists of one of the following: methyl lactate, ethyl lactate, isopropyl lactate, or butyl lactate.

4. The method of claim 1, wherein exposing resin particles to the solvent in a solvent wash tank further comprises:
rotating a carousel including a plurality of wash chambers in the wash tank, and as the carousel rotates, further:
filling each of the plurality of wash chambers with contaminated resin particles as each of the plurality of wash chambers passes a fill position respectively;
agitating the contaminated resin particles in the solvent in the wash chambers respectively;
releasing the resin particles from each of the plurality of wash chambers as each of the plurality of wash chambers passes a release position respectively; and
removing the released particles from the solvent wash tank.

5. The method of claim 4, further comprising friction washing the resin particles removed from the solvent wash tank.

6. The method of claim 5, further comprising separating the resin particles by specific gravity in a sink-float solvent wash tank after friction washing.

7. The method of claim 1, wherein exposing the resin particles to the solvent in the solvent wash tank further comprises successively washing the resin particles in one or more solvent wash tanks.

8. The method of claim 1, wherein exposing the resin particles to the solvent in the solvent wash tank further comprises:
exposing the resin particles to the solvent in a primary sink-float solvent wash tank;
friction washing the resin particles removed from the primary sink-float solvent wash tank; and
exposing the resin particles to the solvent in a secondary sink-float wash tank after the friction washing.

9. The method of claim 1, further comprising selecting the solvent to have a specific gravity to facilitate the separation of different types of the resin particles by density in the solvent wash tank.

10. The method of claim 1, further comprising agitating the resin particles while exposing the resin particles in the solvent in the solvent wash tank.

11. The method of claim 1, further comprising maintaining the temperature of the solvent in the solvent wash tank within the range of 90 to 190 degrees F.

12. The method of claim 1, further comprising mechanically separating the solvent remaining on the resin particles after removal from the solvent wash tank, wherein at least 90 percent of the solvent by weight is removed by the mechanical separation.

13. The method of claim 12, wherein the mechanical separating comprises spinning the resin particles to remove the solvent by centrifugal force.

14. The method of claim 12, wherein the mechanical separating further comprises placing the resin in a sieve or colander and allowing the solvent to drip off the resin particles.

15. The method of claim 1, wherein drying the removed resin particles in the heated chamber further comprises:
circulating a heating fluid around an external surface of the heated chamber, the circulating heating fluid heating the heated chamber;
introducing the resin particles removed from the solvent wash tank into the heated chamber through an inlet of the heated chamber.
rotating a rotating element within the heated chamber to agitate the resin particles; and
facilitating the movement of the resin particles within the heated chamber toward an outlet of the heated chamber.

16. The method of claim 1, further comprising blowing heated air through the heated chamber while facilitating the movement of the resin particles in toward the outlet of the heated chamber,
whereby, the heated air and the heated chamber facilitate the evaporation of solvent off of the resin particles.

17. The method of claim 1, further comprising pulling a vacuum through the heated chamber, the vacuum within the chamber effectively lowering the temperature within the chamber needed to evaporate the solvent off of the resin particles.

18. The method of claim 17, further comprising introducing an inert gas as a carrier into the heated chamber, the inert gas acting as a carrier for facilitating the removal of the evaporated solvent out of the heated chamber.

19. The method of claim 18, wherein the gas is either nitrogen or carbon dioxide.

20. The method of claim 17, wherein the rotating element is a rotating shaft including a plurality of paddles extending outward from the rotating shaft.

21. The method of claim 17, wherein the plurality of paddles are configured to press the resin particles against an internal surface of the heated chamber, the internal surface of the heated chamber opposed to the external surface of the heated chamber in contact with the heating fluid.

22. The method of claim 1, wherein the temperature within the heated chamber ranges from 225 to 300 degrees F.

23. The method of claim 1, further comprising:
recovering contaminated solvent;
distilling the contaminated solvent to remove the contaminants;
reusing the distilled solvent in the solvent wash tank; and
disposing the removed contaminants in an environmentally safe manner.

24. The method of claim 1, wherein the resin consists of one of the following: polypropylene, polyethylene, high density polyethylene, polyethylene terephthalate, nylon, polytetrafluoroethylene, polytetrafluoroethylene, polyvinylidene fluoride, polycarbonate, fluorinated ethylene propylene, polybutylene terephthalate, polyimide, polyetherketone, polyetherimide, polybutylene, polyphenylene oxide, polystryene, polysulfone, polyethersulfone, polymethylpentene, polyvinyl chloride, acetal, acrylic, acrylonitrile-butadiene-styrene (ABS), or any combinations thereof.

25. The method of claim 1, wherein the contaminants comprise one or more of the following substances: volatile polar, non-volatile polar, volatile non-polar, or non-volatile non-polar.

26. The method of claim 1, wherein the contaminants comprise one of the following: soda water, oil, milk, pesticides, detergents, PCB, Benzophenone, 1-Phenyldecane, Toluene and Diethyl-Ketone, chemicals, heavy metals, or any combination thereof.

27. The method of claim 26, wherein the one or more volatile polar, non-volatile polar, volatile non-polar, non-volatile non-polar substances are reduced after drying to one of the following:
(i) at least 0.220 parts per million;
(ii) 0.5 parts per billion after migration testing; or
(iii) both (i) and (ii).

28. An apparatus, the apparatus comprising a system capable of performing the steps recited in method claim 1.

29. A method for recycling resin particles, comprising:
exposing resin particles to an alkyl lactate solvent in a solvent wash tank, the alkyl lactate solvent contacting the resin particles in the solvent wash tank and acting to substantially remove one or more volatile polar, non-volatile polar, volatile non-polar, or non-volatile non-polar contaminants that may reside on the resin particles to a predetermined acceptable level;
mechanically separating the resin particles from the alkyl lactate solvent after the one or more volatile polar, non-volatile polar, volatile non-polar, non-volatile non-polar contaminants have been substantially removed to the predetermined acceptable level from the resin particles in the alkyl lactate solvent; and
drying the separated resin particles in a heated chamber, the heated chamber facilitating the evaporation of residual alkyl lactate solvent remaining on the resin particles after mechanical separation by facilitating the movement of the resin particles through the heated chamber while maintaining a heated environment containing no liquid or supercritical carbon dioxide within the heated chamber.

30. The method of claim 29, wherein exposing the resin particles to the alkyl lactate solvent in a solvent wash tank further comprises:
rotating a carousel including a plurality of wash chambers in the wash tank, and as the carousel rotates, further:
filling each of the plurality of wash chambers with contaminated resin particles as each of the plurality of wash chambers passes a fill position respectively;
agitating the contaminated resin particles in the alkyl lactate solvent in the wash chambers respectively;
releasing the resin particles from each of the plurality of wash chambers as each of the plurality of wash chambers passes a release position respectively; and
removing the released particles from the solvent wash tank.

31. The method of claim 30, further comprising friction washing the resin particles removed from the solvent wash tank.

32. The method of claim 31, further comprising separating the resin particles by density in a sink-float solvent wash tank after friction washing.

33. The method of claim 29, further comprising continually replenishing clean alkyl lactate solvent into the wash tank while continually removing contaminated alkyl lactate solvent from the wash tank.

34. The method of claim 29, further comprising maintaining the temperature of the alkyl lactate solvent in the wash tank in the range of 90 to 190 degrees F.

35. The method of claim 29, wherein mechanically separating the resin particles from the alkyl lactate solvent further comprises one of the following:
(i) spinning the resin particles and removing the alkyl lactate solvent by centrifugal force;
(ii) arranging for the alkyl lactate solvent to drip off the resin particles;
(iii) using a hydro cyclone; or
(iv) any combination of (i) through (iii).

36. The method of claim 29, wherein drying the removed resin particles in a heated chamber further comprises:
circulating a heating fluid around an external surface of the heated chamber, the circulating heating fluid heating the heated chamber;
introducing the separated resin particles into the heated chamber through an inlet of the heated chamber.
rotating a rotating element within the heated chamber to agitate the resin particles in the heated chamber; and
facilitating the movement of the resin particles in the heated chamber toward an outlet of the heated chamber.

37. The method of claim 29, further comprising blowing heated air through the heated chamber while facilitating the movement of the resin particles toward the outlet of the heated chamber, whereby, the heated air and the heated chamber facilitate the evaporation of solvent off of the resin particles.

38. The method of claim 29, further comprising pulling a vacuum through the heated chamber.

39. The method of claim 36, wherein the rotating element is a rotating shaft including a plurality of paddles extending outward from the rotating shaft, wherein the plurality of paddles are configured to press the resin particles against an internal surface of the heated chamber, the internal surface of the heated chamber opposed to the external surface of the heated chamber in contact with the heating fluid.

40. The method of claim 29, wherein the temperature within the heated chamber ranges from 225 to 300 degrees F.

41. The method of claim 29, further comprising:
recovering alkyl lactate solvent contaminated with the one or more volatile polar, non-volatile polar, volatile non-polar, or non-volatile non-polar contaminants;
distilling the contaminated alkyl lactate solvent to remove the one or more volatile polar, non-volatile polar, volatile non-polar, or non-volatile non-polar contaminants;
reusing the distilled alkyl lactate solvent in the solvent wash tank; and
disposing the removed one or more volatile polar, non-volatile polar, volatile non-polar, or non-volatile non-polar contaminants in an environmentally safe manner.

42. The method of claim 29, wherein the resin consists of one of the following: polypropylene, polyethylene, high density polyethylene, polyethylene terephthalate, nylon, polytetrafluoroethylene, polytetrafluoroethylene, polyvinylidene fluoride, polycarbonate, fluorinated ethylene propylene, polybutylene terephthalate, polyimide, polyetherketone, polyetherimide, polybutylene, polyphenylene oxide, polystryene, polysulfone, polyethersulfone, polymethylpentene, polyvinyl chloride, acetal, acrylic, acrylonitrile-butadiene-styrene (ABS), or any combinations thereof.

43. The method of claim 29, wherein the alkyl lactate solvent comprises one or more of the following: methyl lactate, ethyl lactate, isopropyl lactate, or butyl lactate.

44. The method of claim 29, wherein the one or more of the volatile polar, non-volatile polar, volatile non-polar, or non-volatile non-polar substances comprise one or more of the following: Benzophenone, 1-Phenyldecane, Toluene or Diethyl-Ketone.

45. The method of claim 29, wherein the one or more of the volatile polar, non-volatile polar, volatile non-polar, or non-volatile non-polar substances are reduced after drying to one of the following:
(iv) at least 0.220 parts per million;
(v) 0.5 parts per billion after migration testing; or
(vi) both (i) and (ii).

46. The method of claim 29, further comprising removing from the resin particles in the alkyl lactate solvent one or more of the following: soda water, oil, milk, pesticides, detergents or PCBs,

47. An apparatus, the apparatus comprising a system capable of performing the steps recited in method claim 29.
